(19) United States
(12) Patent Application Publication
(10) Pub. No.: US 2017/0352094 A1
(43) Pub. Date: Dec. 7, 2017

(54) AUCTION MANAGEMENT SYSTEMS AND METHODS

(71) Applicant: Amadeus S.A.S., Biot (FR)

(72) Inventors: Jérémy Milhau, Grasse (FR); Jérémie Cottereau, Antibes (FR); Youri Gliere, Le Rouret (FR); Laure Chivot, Antibes (FR)

(21) Appl. No.: 15/171,092

(22) Filed: Jun. 2, 2016

(51) Int. Cl. G06Q 30/08; G06Q 10/08

(52) U.S. Cl. CPC G06Q 30/08; G06Q 10/087

(57) ABSTRACT

Systems, methods, and computer program products for managing an auction. A pool comprised of a first plurality of inventory items that are auction eligible is determined from an inventory item network based on inventory controls. A reference index is determined and assigned to each of the first plurality of inventory items in the pool. The first plurality of inventory items are filtered based on at least one inventory item characteristic to define a second plurality of inventory items. The second plurality of inventory items are filtered based on at least one constraint and the reference index associated with each of the second plurality of inventory items to determine an order in which at least some of the second plurality of inventory items are made available for bidding in the auction.

### TECHNICAL FIELD

The invention generally relates to computers and computer software and, in particular, to systems, methods, and computer program products for managing an auction.

### BACKGROUND

Computerized inventory management systems, in an attempt to optimize resource usage as well as optimize revenue in many service industries, employ revenue-driven and technically complex functionality referred to as revenue management or yield management. For example, some inventory management systems incorporate revenue management systems that incorporate forecasting and optimization functionality, with the former used to forecast or predict future demand, and the latter used to optimize availability (e.g., how much of a managed resource will be offered at different price points).

Managing an inventory of perishable resources, which are lost if not sold, is required in many service industries. An auction designed to sell perishable resources may implicate the use of inventory management systems. An auction sponsored by entities in the service industry as promotions may appeal to customers by offering the potential for reduced pricing and fostering positive public relations. However, auctions may result in a net revenue loss because of the negative impact on the usual demand and a less than fully optimized identification of the perishable resources to sell as part of the auction.

Improved systems, methods, and computer program products for managing an auction are needed that reduce the impact on demand and that provide tighter control over identification of the resources from inventory to sell as part of the auction.

### SUMMARY

In an embodiment, a system for managing an auction may include one or more processors and a memory coupled to the one or more processors. The memory may store data comprising program code that, when executed by the one or more processors, causes the system to determine a plurality of inventory controls and to determine a pool comprised of a first plurality of inventory items that are auction eligible from an inventory item network based on the inventory controls. A reference index is determined and assigned to each of the first plurality of inventory items in the pool. The first plurality of inventory items are filtered based on at least one inventory item characteristic to define a second plurality of inventory items. The second plurality of inventory items are filtered based on at least one constraint. Then the reference index associated with each of the second plurality of inventory items is used to determine an order in which at least some of the second plurality of inventory items are made available for bidding in the auction.

In some embodiments, the program code may further cause the system to determine a weight to associate with each of the first plurality of inventory items in the pool. The filtering of the second plurality of inventory items may be further based on the weight associated with each of the second plurality of inventory items. Additionally, the program code may further cause the system to filter the second plurality of inventory items based on the at least one constraint and the reference index associated with each of the second plurality of inventory items by applying a weight range that must be satisfied by the second plurality of inventory items in order to be made available for bidding in the auction.

In some embodiments, the program code may further cause the system to filter the second plurality of inventory items based on the at least one constraint and the reference index associated with each of the second plurality of inventory items by applying a plurality of selection parameters that determine the order in which the second plurality of inventory items are to be made available for bidding in the auction. Additionally, the program code may further cause the system to filter the second plurality of inventory items based on the at least one constraint and the reference index associated with each of the second plurality of inventory items by determining a weight to associate with each of the first plurality of inventory items in the pool. At least one of the selection parameters is an ordering parameter based on the weight associated with each of the second plurality of inventory items. Additionally, the second plurality of inventory items may be organized at different levels according to a plurality of groups, and at least one of the selection parameters may be a coverage level parameter that sets one of the groups as a level at which the second plurality of inventory items are filtered. Additionally, the second plurality of inventory items may be organized at different levels according to a plurality of groups, and at least one of the selection parameters is a coverage type parameter that limits selection of the second plurality of inventory items from any single one of the groups.

In some embodiments, the second plurality of inventory items may be distributed among a plurality of flight-dates and origin-destinations in the inventory item network.

In some embodiments, the program code may further cause the system to filter the second plurality of inventory items based on the at least one constraint and the reference index associated with each of the second plurality of inventory items by applying a numerical limit representing a maximum number of the second plurality of inventory items to be made available for bidding in the auction.

In some embodiments, the program code may further cause the system to filter the second plurality of inventory items based on the at least one constraint and the reference index associated with each of the second plurality of inventory items by applying one or more revenue constraints that are used to validate the second plurality of inventory items.

In an embodiment, a method of managing an auction includes determining, by one or more processors, a plurality of inventory controls, and determining, by the one or more processors, a pool comprised of a first plurality of inventory items that are auction eligible from an inventory item network based on the inventory controls. The method further includes determining, by the one or more processors, a reference index to assign to each of the first plurality of inventory items in the pool, and filtering, by the one or more processors, the first plurality of inventory items based on at least one inventory item characteristic to define a second plurality of inventory items. The method further includes filtering, by the one or more processors, the second plurality of inventory items based on at least one constraint and the reference index associated with each of the second plurality of inventory items to determine an order in which at least some of the second plurality of inventory items are made available for bidding in the auction.

In some embodiments, the method may further include determining, by the one or more processors, a weight to associate with each of the first plurality of inventory items in the pool. The filtering of the second plurality of inventory items may be further based on the weight associated with each of the second plurality of inventory items. Additionally, the filtering the second plurality of inventory items based on the at least one constraint and the reference index associated with each of the second plurality of inventory items may comprise applying, by the one or more processors, a weight range that must be satisfied by the second plurality of inventory items in order to be made available for bidding in the auction.

In some embodiments, filtering the second plurality of inventory items based on the at least one constraint and the reference index associated with each of the second plurality of inventory items may comprise applying, by the one or more processors, a plurality of selection parameters that determine the order in which the second plurality of inventory items are to be made available for bidding in the auction. Additionally, filtering the second plurality of inventory items based on the at least one constraint and the reference index associated with each of the second plurality of inventory items may comprise determining, by the one or more processors, a weight to associate with each of the first plurality of inventory items in the pool. At least one of the selection parameters may be an ordering parameter based on the weight associated with each of the second plurality of inventory items. Additionally, the second plurality of inventory items may be organized at different levels according to a plurality of groups, and at least one of the selection parameters is a coverage level parameter that sets one of the groups as a level at which the second plurality of inventory items are filtered. Additionally, the second plurality of inventory items may be organized at different levels according to a plurality of groups, and at least one of the selection parameters is a coverage type parameter that limits selection of the second plurality of inventory items from any single one of the groups.

In some embodiments, the second plurality of inventory items may be distributed among a plurality of flight-dates and origin-destinations in the inventory item network.

In some embodiments, filtering the second plurality of inventory items based on the at least one constraint and the reference index associated with each of the second plurality of inventory items comprises applying a numerical limit representing a maximum number of the second plurality of inventory items to be made available for bidding in the auction.

In some embodiments, filtering the second plurality of inventory items based on the at least one constraint and the reference index associated with each of the second plurality of inventory items comprises applying one or more revenue constraints that are used to validate the second plurality of inventory items.

In an embodiment, a computer program product is provided for managing an auction. The computer program product includes a non-transitory computer-readable storage medium and program code stored on the non-transitory computer-readable storage medium. The program code, when executed by one or more processors, causes the one or more processors to determine a plurality of inventory controls, determine a pool comprised of a first plurality of inventory items that are auction eligible from an inventory item network based on the inventory controls, and determine a reference index to assign to each of the first plurality of inventory items in the pool. The first plurality of inventory items are filtered based on at least one inventory item characteristic to define a second plurality of inventory items. The second plurality of inventory items are filtered based on at least one constraint and the reference index associated with each of the second plurality of inventory items to determine an order in which at least some of the second plurality of inventory items are made available for bidding in the auction.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including an auction campaign system in communication via a network with other systems.

FIG. 2 is a flow chart illustrating a process by which a pool of seats with weights can be defined in accordance with an embodiment of the invention.

FIG. 3 is a flow chart illustrating a process by which an auction campaign can be defined in accordance with an embodiment of the invention.

FIG. 4 is a flow chart illustrating a process by which a business rule can be activated to conduct an auction campaign in accordance with an embodiment of the invention.

FIG. 5 is a diagrammatic view of an exemplary computing system for hosting the auction campaign system of FIG. 1 or any of the other systems of FIG. 1.

### DETAILED DESCRIPTION

Embodiments of the invention may be implemented by a processing and database system that may, at a different granularity level, comprise one or more computerized systems, such as an auction campaign system, an inventory system, a pricing engine, and a revenue management system. Each of these systems may be a part of, or provided by, a Global Distribution System (GDS), a system operated by a provider of travel products, or any other suitable processing and database system.

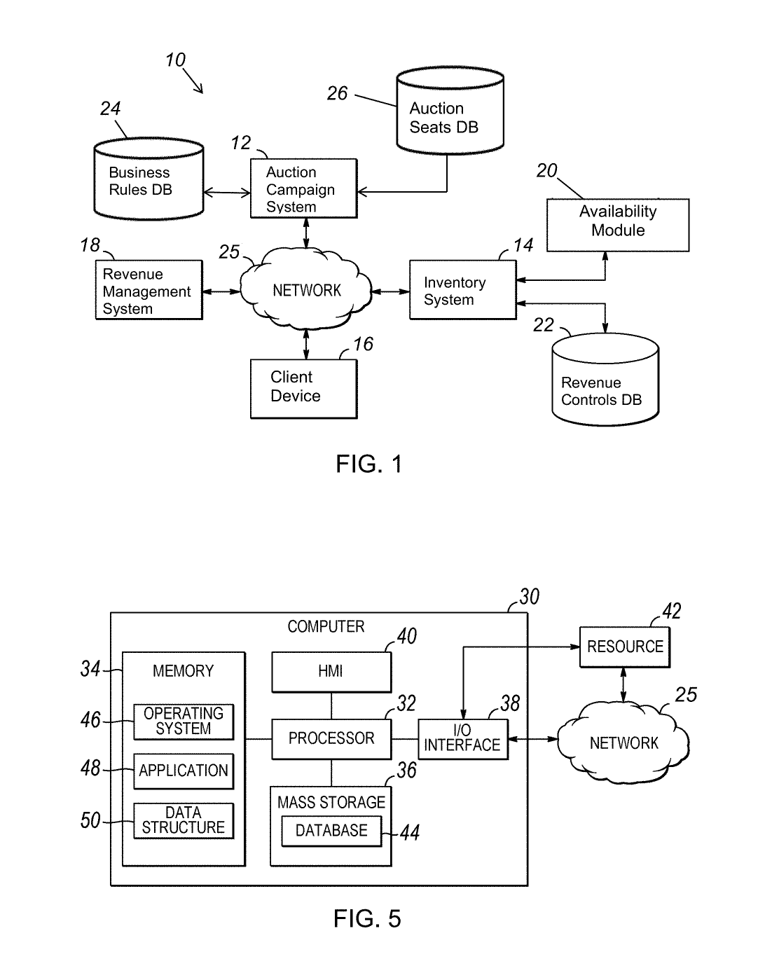

Referring now to FIG. 1, an operating environment 10 in accordance with embodiments of the invention may include an auction campaign system 12, an inventory system 14, a client device 16 associated with an actor (e.g., a travel provider employee, a customer, or a travel agent), a revenue management system 18, an availability module 20, a revenue controls database 22, a business rules database 24, and an auction seats database 26 that are connected with each other through a network 25. The network 25 may include portions of one or more private or public networks (e.g., the Internet, a virtual private network, a local area network, a wide area network, a cellular telephone network, etc.) that provide interconnection and facilitate the exchange of data containing information. In an embodiment, the auction campaign system 12 may be integrated with the inventory system 14 and/or the revenue management system 18, and one or more of these systems 12, 14, 18 may be operated by the same business entity.

The inventory system 14 is a computerized system that stores, as perishable inventory units or items, seats for multiple flight-dates belonging to an airline network, as well as cabins and/or booking classes for each such flight-date. The inventory system 14 may be used by, for example, an airline to manage a stock of seats offered as a network of inventory items on its own flights and flights of commercial partners through the implementation of inventory controls. The inventory controls may be managed to adjust the manner in which seats of different characteristics are made available to customers in order to maximize revenue or to achieve marketing objectives.

Each client device 16 may be an electronic device including hardware, software, or embedded logic components and capable of carrying out supported functionalities. Representative client devices 16 may include a computer system such as a desktop computer, or a mobile electronic device such as a notebook or laptop computer, a tablet computer a cellular telephone, a smartphone, etc. Each client device 16 may enable its user to communicate with the auction campaign system 12 via the network 25 using a graphical user interface, a dedicated web page, cryptic command entry, etc.

The revenue management system 18 is a computerized system configured to optimize the revenue generated from the inventory of perishable seats for flight-dates of an airline network maintained in an inventory database. The revenue management system 18 may rely on statistical techniques to forecast and operations research algorithms to estimate demand and make inventory control decisions based on historical data. The revenue management system 18 may continuously monitor passenger demand, market trends, and pricing activity to provide an optimum inventory allocation. The output from the revenue management system 18 may include data such as yields, bid price vectors, etc. The revenue management system 18 may have access to the availability module 20 and to the revenue controls database 22.

The revenue management system 18 may be configured to determine an expected future revenue impact of making units of inventory available for purchase in each of several booking classes to provide segmented pricing. The revenue management system 18 may determine availability levels and prices to maximize the revenue generated by the sale of the seats. The travel product may have a limited inventory, and a perish time by which the inventory must be sold to avoid loss of any unsold units of inventory.

The revenue management system 18 may separate the process of revenue optimization into pricing and inventory control functions. Pricing may be segmented by establishment of booking classes, and may involve tariffs within those classes for each specific market. Product inventory control may be implemented by periodic adjustment of nested booking limits for the various classes of service so as to optimize the passenger mix, thereby optimizing the generated revenue. In particular, the objective may be to fly each aircraft as full as possible without allowing earlier-booking discount-fare passengers to displace later-booking full-fare passengers.

The cost of not selling a unit of inventory may be a current expected value of selling the unit at some time in the future (e.g., an opportunity cost or bid price). The bid price may vary depending on the amount of remaining inventory and the amount of time remaining until the perish time. The bid price may represent a probabilistic expected revenue for the next seat offered to sell for a given remaining inventory and amount of time until the service perishes. To maximize revenue for this limited inventory, the revenue management system 18 may open and close certain cabins and classes of service based on the bid price. This gating strategy may be based on bid prices computed on a periodic basis (e.g., daily), which may in turn be used to determine availability for each booking class. Plotting the bid price as a function of remaining units of inventory at time may produce a bid price vector. The bid price vector may provide a minimum price the carrier should accept for booking the next available seat for a given remaining inventory and time.

The revenue management system 18 may determine how many units from the remaining inventory should be made available in each booking class based on the bid-price and yield. The yield may reflect an expected revenue per unit sold, and may vary by booking class, market, and perish date for units of inventory. If the bid-price is less than the yield, units of inventory may be made available in the booking class. In contrast, if the bid-price is greater than the yield, the booking class should be closed because the opportunity cost of the next unit of inventory exceeds the price for which the ticket is expected to sell.

The availability module 20 may query an inventory database to determine inventory item availability. In general, the availability module 20 may calculate availability of inventory items (i.e., places or spaces such as seats on a travel conveyance) based at least in part on information stored in the inventory database.

The auction campaign system 12 is configured to manage auction campaigns provided as a promotion for a travel provider (e.g., an airline) and to optimize seat selection to ensure that the sales from an auction campaign are consistent with the revenue objectives of the travel provider. The auction campaign system 12 may have access to the business rules database 24 and to the auction seats database 26. The auction campaign system 12 may interact with the revenue management system 18 without any modification to the revenue management system 18.

A segment may refer to the operation of an aircraft between one point where passengers first board the aircraft and another point where the passengers exit the aircraft for a final time. A segment may include any number of stops where passengers can exit and re-board the same aircraft. A leg may refer to the operation of an aircraft from one scheduled departure station to its next scheduled arrival station. Thus, a segment may include one or more legs flown by a single aircraft.

A flight may refer to the operation of one or more segments with the same flight designator, and may involve more than one aircraft. A travel solution may refer to a combination of one or more flights that provides one-way travel from a specific origin to a specific destination, and that departs from the origin at a specific time. Thus, a travel solution may include a specific instance of travel between an origin and a destination. Travel solutions matching the search terms of a search query may be returned as a search result, and if a space is available on the travel solution, the space may be booked by the searcher for travel from the origin to the destination.

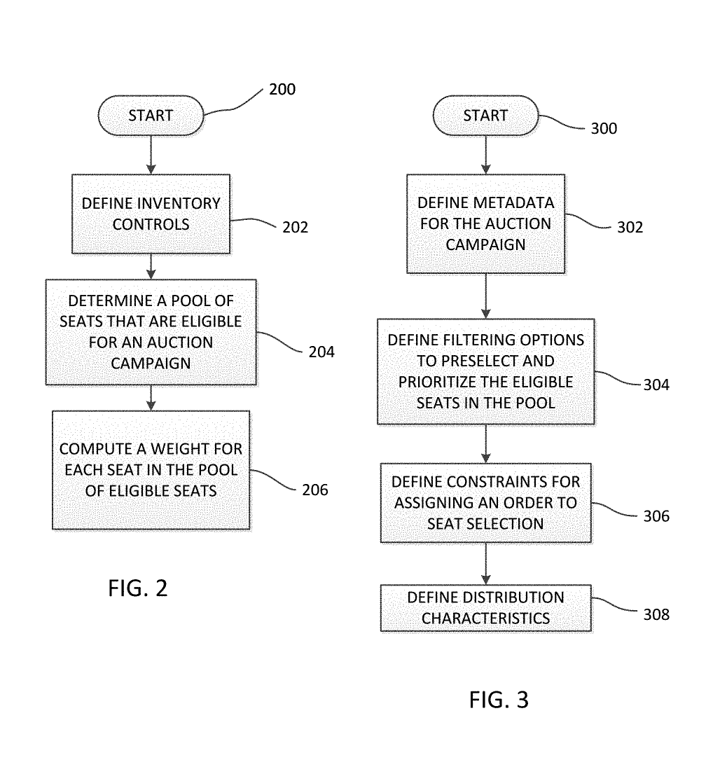

FIG. 2 is a flow chart illustrating a process 200 for defining a pool of the seats eligible to be included in an auction and assigning a weight to each of the most relevant seats for use in seat selection in accordance with an embodiment of the invention. The pool of seats may be stored in the auction seats database 26 and, when needed, may be retrieved from the auction seats database 26.

In block 202, inventory controls are established to limit the number of seats participating in the promotional campaign. To that end, inventory counters are defined in the inventory system 14 to track the seats subject to an auction. The auction campaign system 12 may use one of these inventory counters [Bookings (sold via auction)] to count and track the number of seats sold per leg and cabin for each flight-date through auctions at any instant in time. The auction campaign system 12 may use one of these inventory counters [Bookings (under auction)] to count the number of seats that are currently part of an auction campaign at any instant in time on a given leg/cabin/date. As used herein, a leg represents a flight of an aircraft between an origin (i.e., boarding point) and a destination (i.e., deboarding point) on any given flight-date, a cabin is a physical section of an airplane, such as the first class cabin, the economy cabin, a seat is a place in a cabin that is saleable on a leg, etc.

The auction campaign system 12 defines a maximum number of seats to be sold through auctions per leg and cabin through the establishment of a control within the inventory system. The numerical value assigned to the [Max (seats auction)] control is, at any instant in time, a maximum number of seats that can be sold through auctions for a given leg and cabin. The definition of the [Max (seats auction)] control considers the attributes of the considered leg and cabin. However, attributes relating to the pressure on the flight (e.g., either current pressure through the load factor for instance or forecasted pressure) may be ignored in setting the [Max (seats auction)] control. The numerical value assigned to the [Max (seats auction)] control may be set manually, as a default value by the inventory system 14, as a value optimized by the revenue management system 18, or in a different manner.

In an embodiment, the numerical value for the [Max (seats auction)] control may be set equal to a given factor, α, times an authorization level (AU):

Max (seats auction)=α×AU

The factor α may range in numerical value between 0 to 1 and may depend on leg/cabin parameters such as cabin, market, and criticality indicator of the associated flight segment. The authorization level is a leg/cabin authorization level representing the saleable capacity determined considering overbooking forecasts. In an embodiment, the [Max (seats auction)] control may be defined through the application of business rules and may be stored at the leg and cabin level in the revenue controls database 22.

In block 204, the auction campaign system 12 may determine a pool of seats that are potentially available and therefore eligible to be auctioned using the [Max (seats auction)] control and other factors. Based on the control and the counters, the auction campaign system 12 can determine, for each leg/cabin, a number of seats potentially available for auctions:

Basic Auction Availability (leg/cabin)=Max (seats auction)−Bookings (sold via auction)−Bookings (under auction)

In an embodiment, the revenue management system 18 may be able to compute a slack space representing the number of seats that are unlikely to be sold on a given combination of leg and cabin, which may be supplied to the auction campaign system 12. In this instance, the auction availability per leg and cabin may be computed by the auction campaign system 12 as:

Auction Availability (leg/cabin)=MIN[β×Slack Space),Basic Auction Availability (leg/cabin)],

wherein β is a factor between 0 and 1 that can be customized depending on the context (cabin, market, criticality of the flight, authorization level, etc.), and the [MIN] function returns the smallest numerical value of the set of elements under evaluation. The auction campaign system 12 may receive synchronized and updated value of the slack space from the revenue management system 18 upon each recalculation for a riven flight-date.

In another embodiment, the revenue management system 18 may be unable to compute slack space. In this instance, the auction availability per leg and cabin may be computed by the auction campaign system 12 as:

Auction Availability (leg/cabin)=MIN[(β×AU(1−expected load factor)),Basic Auction Availability (leg/cabin)],

where the expected load factor and the authorization level are received from the inventory system 14, and may be updated by the revenue management system 18 as needed.

A seat that has not yet considered in an auction can be included in a new promotional campaign only if the Auction Availability(leg/cabin) associated with the seat under consideration remains positive. At any given time with a current seat index “n” for a given flight, date, leg, and cabin, only seats tagged with seat index between “n” and “n−Auction Availability+1” can be sold. The seat indices that are eligible for an auction at any given time can be determined based on a bid-price vector. The bid-price vector embodies bid-prices for incremental seats (i.e., an inventory item) in a leg and cabin on a particular flight-date. The bid-price represents a minimum revenue at which a travel provider (e.g., an airline) is willing to sell an associated inventory item.

For example and as shown in logical Table 1, a given flight scheduled for a given flight date may have a leg/cabin with the following bid-price vector in which the current seat index, which represents the next seat available for sale in the considered leg cabin, is given by the row in the table with seat index “n”. The remaining seat index is a reference index that presents the seats in the bid-price vector for a given flight, flight date, leg, and cabin in the reverse order of the seat index. Such a representation is unconventional relative to past practices for presenting seats in a bid-price vector.

TABLE 1

| Seat Index | Remaining seat index | Bid-Price |
|---|---|---|
| 1 | n | 1000 |
| 2 | n − 1 | 900 |
| . . . | . . . | . . . |
| n − 2 | 3 | 300 |
| n − 1 | 2 | 120 |
| n | 1 | 100 |

If the Auction Availability (leg/cabin) is determined for this given leg/cabin to be equal to 2, then the seats available for sale in an auction campaign are the seats characterized by the seat indexes “n” and “n−1”. The remaining seat index represents the number of bookings needed to consider a seat in a given leg/cabin as sold. In the example with the Auction Availability equal to 2 and as shown in logical Table 2, the remaining seat indexes 3, 4, . . . , n fail the test and are therefore not eligible seats to be auctioned.

TABLE 2

| | | | Eligible for |
|---|---|---|---|
| Seat Index | Remaining Seat Index | Bid-Price | auction? |
| 1 | n | 1000 | Not eligible |
| 2 | n − 1 | 900 | Not eligible |
| . . . | . . . | . . . | . . . |
| n − 2 | 3 | 300 | Not eligible |
| n − 1 | 2 | 120 | Eligible |
| N | 1 | 100 | Eligible |

In block 206, the auction campaign system 12 computes a weight for each eligible seat, taking into consideration the seat index, at the leg and cabin level over all legs/cabins of the airline network. The weights are used to compare different seats in order to select the eligible seats to sell through auctions and to put those eligible seats in an ordered relationship. The seat weight, which is associated with the bid price vector, enables the auction campaign system 12 to compare seats on a single route or seats across different routes. The weight may be recomputed every time that the inventory system 14 recalculates the availability of a flight-date. The weight may be extracted and stored in the auction seats database 26, which promotes efficient parsing of this information when the auction campaign system 12 builds an auction campaign.

The weight may be computed by the auction campaign system 12 in various different ways. The weight is linked to the characteristics of the considered seat and the related leg and cabin, but is independent of the context of the sale (e.g., point of sale). The seat weight may be computed by a dedicated module at the auction campaign system 12 that tailors the computation to the type of auction product, such as a Dutch auction or reverse auction, an ascending auction, opaque bookings, etc. In an embodiment, the auction product may be a Dutch auction in which the auction's bid price starts at a given initial value and is incrementally lowered by a fixed amount at specified time intervals until a bid happens to win the auction.

The computation of the weights by the auction campaign system 12 may be based on multiple components each of which represents the importance of the considered seat from a different perspective. For each type of auction product, the auction campaign system 12 may reply upon weighting factors to select which components to include or which components to not include in weight computation and the respective importance of the included components. To that end, the components used by the auction campaign system 12 in the computation may be selected by the auction campaign system 12 through the assignment or designation of weighting factors. The auction campaign system 12 may compute a weight for each seat by assigning a weighting factor ranging from 0 to 1 to each component that reflects relative importance and then summing the weighted components. This may be expressed as:

Weight(seat i)=Σi(αi×Component(i)),

where Σi (αi)=1.

For each seat available for auction, the auction campaign system 12 may determine values for the different components used in the computation. By construction, the values may be normalized to range from 0 to 1.

A representative component that may be factored into the computation of seat weight by the auction campaign system 12 is a booking pressure component that is intended to reflect the booking pressure on the considered leg and cabin. The auction campaign system 12 may compute the booking pressure based on an expected load factor of each flight-date containing seats available for auctions. The booking pressure may be computed based on a minimum value of expected load factor MIN(ELF) and a maximum value of expected load factor MAX(ELF). If the values for the minimum and maximum estimated load factors are identical, then the booking pressure component is ignored in the computation of seat weight (i.e., αi=0). For each seat, the booking pressure component may be expressed as:

Booking Pressure component (seat i)=[ELF(seat i)−MIN(ELF)]/[MAX(ELF)−MIN(ELF)],

where ELF (seat i) represents the expected load factor of the leg/cabin of the flight date in which the seat i is included.

Another representative component that may be factored into the computation of seat weight by the auction campaign system 12 is a slack space component that reflects an importance of the slack space on the considered leg and cabin. The slack space component may be computed by the auction campaign system 12 based on the slack space of each flight-date containing seats available for auctions. The slack space may be computed based on a minimum value of slack space MIN(Slack Space) and a maximum value of slack space MAX(Slack Space). If the values for minimum and maximum slack space are identical, then the slack space component is ignored in the computation of seat weight (i.e., αi=0). For each seat, the slack space component may be expressed as:

Slack Space component (seat i)=[(Slack Space (seat i)−MIN(Slack Space)]/[MAX(Slack Space)−MIN(Slack Space)].

Another representative component that may be factored into the computation of seat weight by the auction campaign system 12 is an expected revenue component that reflects an importance of the expected revenue for the considered seat. The auction campaign system 12 may compute the expected revenue component based on the bid price for each seat available for auctions. The expected revenue component may be computed based on a minimum value of bid price MIN(Bid Price) and a maximum value of bid price MAX(Bid Price). If the values for minimum and maximum bid price are identical, then the expected revenue component is ignored in the computation of seat weight (i.e., αi=0) by the auction campaign system 12. For each seat, the expected revenue component may be expressed as:

Expected revenue component (seat i)=1−[(Bid Price(seat i)−MIN(Bid price)]/[MAX(Bid price)−MIN(Bid price)].

Another representative component that may be factored into the computation of seat weight by the auction campaign system 12 is an impact on usual sales component that reflects the impact of selling a seat through auctions on the usual sales. The auction campaign system 12 may compute the impact on usual sales component based on the difference of the bid price for a seat and the bid price of the next seat for sale. The impact on usual sales component may be computed based on a minimum value of the difference MIN(ΔBP) and a maximum value of the difference MAX(ΔBP). If the values for minimum and maximum difference are identical, then the impact on usual sales component is ignored in the computation of seat weight (i.e., αi=0). For each seat, the impact on usual sales component may be expressed as:

Impact on usual sales component (seat i)=[ΔBP(i)−MIN(ΔBP)]/[MAX(ΔBP)−MIN(ΔBP)].

For each seat available for auction, the auction campaign system 12 computes a weight, as described hereinabove, and associates the weights with the seats in a list of seats available for auction. This list is stored in a dedicated table within the auction seats database 26, and is categorized by groups at different levels of coverage. An example of a dedicated table with seats available on different flight-dates for inclusion in an auction campaign and their associated weights is provided in logical Table 3 in which the list is grouped at different levels by Origin-Destination (O&D), flight number, departure date, and two different cabins (Y and C).

TABLE 3

| | | Origin - Destination | | | | | |
|---|---|---|---|---|---|---|---|
| | | LHR-SIN | | | LHR-BKK | | SYD-CDG |
| | | Flight Number | | | | | |
| | | 6X 123 | | | 6X 456 | | 6X 789 |
| | | Departure Date | | | | | |
| | | 10MAR | | 12MAR | 10MAR | 20MAR | 25MAR |
| | | Cabin | | | | | |
| | | C | Y | Y | Y | Y | C |
| Remaining | RSI 1 | 0.89 | 0.93 | 0.96 | 0.88 | 0.68 | 0.65 |
| Seat Index | RSI 2 | 0.85 | 0.75 | 0.79 | 0.76 | 0.56 | |
| | RSI 3 | | 0.84 | 0.74 | 0.33 | 0.49 | |
| | . . . | | . . . | | . . . | . . . | |
| | RSI MAX-1 | | 0.46 | | 0.22 | | |
| | RSI MAX | | 0.34 | | | | |

The pool of the seats to be included in an auction may be based on types of inventory categorizations other than O&D. Examples include, but are not limited to, markets at country level or operating/marketing status of the flight, departure time, aircraft type, etc.

Following each update of any flight date inventory, the pool of seats and their associated weight may be recomputed. At a given time, the pool of seats represents a list of remaining eligible seats that could participate in a new auction campaign. The seat weights can be extended to any group of seats at different levels, such as leg/cabin, flight date, or flight number, in order to be able to compare such groups. For example, the weight of a group of seats may be defined as the maximum weight among the seats, the average seat's weight, the minimum weight, etc.

FIG. 3 is a flow chart illustrating a process by which an auction campaign can be defined in accordance with an embodiment of the invention. The auction campaign system 12 may be used to define the auction campaign after the weights are assigned to the seats that are available for auction.

In block 302, a customizable business rule is generated by populating different sections of the business rule, referred to herein as the auction campaign rule, with attributes to define the campaign and determine which seats should be offered in a given auction. An analyst for the travel provider may use an interface at his or her client device 16 to provide information that is received by the auction campaign system 12 and used to generate the business rule.

The business rule may be composed of multiple sections with different functions. One section of the business rule may define metadata that identifies a given campaign. Another section of the business rule may define filtering options that are used to select seats from the auction seats database 26 that could potentially participate in an auction campaign. Yet another section of the business rule may define constraints that may be designated to end the application of the business rule and thereby halt the auction campaign when either one or more thresholds or seats characteristics are reached. Yet another section of the business rule may select distribution characteristics that define the pricing attributes and validity period of the auction campaign.

The section of the business rule that defines the metadata may include information such as a name for the auction campaign, an objective for the auction campaign, comments regarding the auction campaign, keywords associated with the auction campaign, and an individual who approved the auction campaign. In an embodiment, the only mandatory element of the metadata may be the name of the auction campaign. Following the definition of the name of the auction campaign, a draft version of the business rule may be saved in the business rules database 24 without actual deployment to block any seats for an auction campaign and later retrieved from storage to update one or more of the sections. The business rules database 24 may also contain business rules that are directed to live auction campaigns deployed and blocking seats as part of the live auction campaign.

In block 304, the auction campaign system 12 receives filtering options that may be used to preselect and prioritize a list of seats, which is stored in and retrieved from the auction seats database 26, for potential participation in an auction campaign. One filtering option is applied to filter the pool of seats that are eligible for auction according to the characteristics of the seats. The characteristics may include, but are not limited to, market origin, market destination, a range of departure dates, a flight group by flight number, and/or cabin. Filtering by one or more of the seat characteristics selects a subset of the pool of eligible seats that should participate in the campaign. More specifically, the auction campaign system 12 dynamically searches the seats stored in the auction seats database 26 to find seats that match one or more of the characteristics and builds a filtered list of auction seats. By default, the filtered list of auction seats is set equal to the pool of seats.

As an example of preselecting and prioritizing a list of seats for potential participation in an auction campaign, a campaign may be created with the seats characteristics defined in Table 4 and applied to filter the seats in the pool of Table 3 to select a filtered list of auction seats, which is displayed in Table 5. Flight Number 6X 789 for the O&D SYD-CDG in Table 3 fails to satisfy the Departure Date Range specified in the seats characteristics of Table 4, and Cabin C of Flight Number 6X 123 in Table 3 fails to satisfy the Cabin specified in the seats characteristics of Table 4, which removes them from the list of filtered seats in logical Table 5.

TABLE 4

| Market | Market | | Flight | |
|---|---|---|---|---|
| Origin | Destination | Departure Date Range | Group | Cabin |
| WORLD | WORLD | From 05MAR to 20MAR | | Y |

TABLE 5

| | | Origin - Destination | | | |
|---|---|---|---|---|---|
| | | LHR-SIN | | LHR-BKK | |
| | | Flight Number | | | |
| | | 6X 123 | | 6X 456 | |
| | | Departure Date | | | |
| | | 10MAR | 12MAR | 10MAR | 20MAR |
| | | Cabin | | | |
| | | Y | Y | Y | Y |
| Remaining | RSI 1 | 0.93 | 0.96 | 0.88 | 0.68 |
| Seat Index | RSI 2 | 0.75 | 0.79 | 0.76 | 0.56 |
| | RSI 3 | 0.84 | 0.74 | 0.33 | 0.49 |
| | . . . | . . . | | . . . | . . . |
| | RSI MAX-1 | 0.46 | | 0.22 | |
| | RSI MAX | 0.34 | | | |

In addition, one or more key performance indicators (KPIs) may be dynamically computed as business metrics and displayed to an analyst. Among these KPIs may be a total number of seats matching the seat characteristics used in seat filtering, a total number of different flight numbers impacted, a total number of different flight/date/cabins impacted, an average number of seats per flight/date/cabin, minimum/maximum/average weights, etc. These KPIs can be used by the analyst to refine and/or modify the filtering that is performed on the pool of auction seats.

Assuming that RSI MAX is equal to 6, the following key performance indicators would be returned the filtered list of seats in Table 5. The total number of seats matching the characteristics used in seat filtering is equal to 18 (6+3+5+4). The total number of different Flight Numbers impacted is equal to 2. The total number of different flight/date/cabins impacted is equal to 4. The average number of seats per Flight/Date/Cabin is equal to 4.5 (18/4). The minimum weight is equal to 0.22 and the maximum weight is equal to 0.96.

The seats are then tentatively placed in an order for consideration in an auction campaign. To that end, the auction campaign system 12 receives and applies revenue specific constraints (Yields, Prices, etc. . . . ) that should be respected by the seats from the filtered list of auction seats that are available to participate in an auction. For example, a constraint may be that only 100 seats on as few flight dates as possible should be promoted while still considering the most interesting seats from a weight perspective. As another example, a constraint may be that a maximum of 10,000 seats should be promoted that possess the following characteristics: a weight greater than 0.9, a standard price less than or equal to 100 EUR, seats in as many flight dates as possible, and seats selected in a random manner.

The auction campaign system 12 may receive and apply optional counter constraints representing numerical limits that are applied. For example, selected seats may be required to have a weight within a valid weight range. As another example, the seat selection process may be terminated when a given total number of seats limit is reached. During the auction campaign application process, the auction campaign system 12 validates which seats are pre-booked in the auction. For each seat positively considered in the auction, relevant campaign counters are updated. As soon as one limit is reached, the campaign application process may be terminated.

The auction campaign system 12 may receive and apply a set of seat selection parameters for use in defining auction campaign rules. The seat select parameters are applied to select how the seats should be selected in an auction campaign in order to introduce some randomness in the selection logic considered. The element of randomness may be used to ensure that the same seats from the usual same flights are not consistently included in the auctions, which could adversely impact the customer consumption habits over the long term if not negated. This aids in ensuring that passengers cannot predict future campaigns such that normal demand is not cannibalized by selling seats through auction campaigns. The seat selection parameters may include coverage parameters, such as a level coverage parameter (e.g., Origin and Destination (O&D); Flight Number, Flight Date, Flight Date/Cabin, Seat) and a type coverage parameter (e.g., As many as possible; As few as possible). The seat selection parameters may include an ordering parameter with options such as Highest Weight First or Random Weight First, as further discussed below. These parameters are used to determine an order in which the filtered list of auction seats will be evaluated by the auction process.

For purposes of illustration and starting with the filtered list of auction seats and associated weights in Table 5, the auction campaign system 12 may determine auction campaign rules with the following exemplary seat selection parameters. Generally and independent of the specific seat selection parameters, a particular seat in the filtered list may be considered by the auction campaign system 12 if, and only if, all smaller RSI's of the same flight/date/leg/cabin have been included in this auction. As a consequence of this limitation, the auction campaign system 12 initially considers only the seat associated with RSI 1 (the seat with the lowest remaining seat index) as selectable for any given flight/date/leg/cabin.

The initial seat is selected as part of the auction campaign by considering the ordering parameter. If the ordering parameter is equal to Highest Weight First, then the system 12 chooses the seat, from among the seats in the pool designated as RSI 1, within the weight range having the highest weight. In Table 5, this ordering parameter would result in the selection of the seat designated as RSI 1 for LHR-SIN on flight number 6X 123 on 12MAR in Y cabin, which has a weight equal to 0.96. Alternatively, if the ordering parameter is equal to Random Weight First, then the system would randomly select a seat among the seats designated with the RSI 1 within the weight range. At the end of this initial seat selection process, the total number of seats already considered in the auction is incremented by 1.

The selection process continues with the selection of additional seats to include in the pool as long as the total number of seats included is below the counter constraint defining a maximum number of seats. In particular, seat selection continues to select additional seats to place in the pool based on a combination of the coverage level and coverage type parameters.

The coverage level parameter may be set to “Seat” and the coverage type parameter may be set to either “As few as possible” or “As many as possible”. If the coverage type parameter is set to “As few as possible”, then the system 12 selects the seat having the highest weight from among the remaining seats within the weight range. If the coverage type parameter is set to “As many as possible”, the system 12 takes the seat among the remaining seats within the weight range that has the highest weight. If some eligible Flight/Date/Leg/Cabin combinations have not yet had a seat considered as part of the auction, the system looks first in these combinations. If all eligible Flight/Date/Leg/Cabin combinations have already had a seat considered or if there is no seat respecting the weight range condition in the Flight/date/Leg/Cabin combinations not yet considered, the system 12 simply takes the seat having the highest weight.

The coverage level parameter may be set to “Flight Date/Cabin” the coverage type parameter may be set to either “As few as possible” or “As many as possible”. If the coverage type parameter is set to “As few as possible”, then the system 12 selects the seat having the highest weight from among the remaining seats within the weight range and with a priority given to the same Flight/Date/Leg/Cabin as the previous seat selected. If there are no more eligible seats (no seat at all or no seat matching the weight and RSI constraints) in the considered Flight/Date/Leg/Cabin, then the system 12 takes the seat with the highest weight from among the remaining seats within the weight range. If the coverage type parameter is set to “As many as possible”, the system 12 takes the seat among the remaining seats within the weight range that has the highest weight, in priority in a Flight/Date/Leg/Cabin not yet considered. If some eligible Flight/Date/Leg/Cabin combinations have not yet had a seat considered as part of the auction, the system 12 looks first in these combinations. If all eligible Flight/Date/Leg/Cabin combinations have already had a seat considered or if there is no seat respecting the weight range condition in the Flight/Date/Leg/Cabin combinations not yet considered, the system 12 simply takes the seat having the highest weight in priority in the same Flight/Date/Leg/Cabin as the previous seat selected.

The coverage level parameter may be set to “Flight Date” and the coverage type parameter may be set to either “As few as possible” or “As many as possible”. If the coverage type parameter is set to “As few as possible”, then the system 12 selects the seat having the highest weight from among the remaining seats within the weight range and with a priority given to the same Flight/Date as the previous seat selected. If there are no more eligible seats (no seat at all or no seat matching the weight and RSI constraints) in the considered Flight/Date, then the system 12 takes the seat with the highest weight from among the remaining seats within the weight range. If the coverage type parameter is set to “As many as possible”, the system 12 selects the seat having the highest weight from among the remaining seats within the weight range and with a priority given to the Flight/Date combinations not previously considered. However, if some eligible Flight/Date combinations have not yet had a seat considered as part of the auction, the system 12 looks first in these combinations. If all eligible Flight/Date combinations have already had a seat considered or if there is no seat respecting the weight range condition in the Flight/Date combinations not yet considered, the system 12 simply takes the seat having the highest weight in priority in the same Flight/Date as the previous seat selected.

The coverage level parameter may be set to “Flight Number” and the coverage type parameter may be set to either “As few as possible” or “As many as possible”. If the coverage type parameter is set to “As few as possible”, then the system 12 selects the seat having the highest weight from among the remaining seats within the weight range and with a priority given to the same Flight Number as the previous seat selected. If there are no more eligible seats (no seat at all or no seat matching the weight and RSI constraints) in the considered Flight Number, then the system 12 takes the seat with the highest weight from among the remaining seats within the weight range. If the coverage type parameter is set to “As many as possible”, the system 12 system takes the seat from among the remaining seats within the weight range that has the highest weight, in priority in a Flight Number not considered yet. If some eligible Flight Numbers have not yet had a seat considered as part of the auction, the system 12 looks first in these combinations. If all eligible Flight Numbers already have had a seat considered or if there is no seat respecting the weight range condition in the Flight Numbers not considered yet, the system 12 simply takes the seat having the highest weight in priority in the same Flight Number as the previous seat selected.

The coverage level parameter may be set to “O&D” and the coverage type parameter may be set to either “As few as possible” or “As many as possible”. If the coverage type parameter is set to “As few as possible”, then the system 12 selects the seat having the highest weight from among the remaining seats within the weight range and with a priority given to the same O&D/Leg/Cabin as the previous seat selected. If there are no more eligible seats (no seat at all or no seat matching the weight and RSI constraints) in the considered O&D, then the system 12 takes the seat with the highest weight from among the remaining seats within the weight range. If the coverage type parameter is set to “As many as possible”, the system 12 takes the seat from among the remaining seats within the weight range that has the highest weight, in priority in a O&D not already considered. If some eligible O&D's have not yet had a seat considered as part of the auction, the system 23 looks first in these combinations. If all eligible O&D's already have had a seat considered or if there is no seat respecting the weight range condition in the O&Ds not considered yet, the system 12 simply takes the seat having the highest weight in priority in the same O&D as the previous seat selected.

The auction campaign system 12 may be used by an analyst to execute an iterative process starting with a set of values for the seat selection parameters in order to determine a prioritized filtered list of auction seats. The system 12 dynamically searches in the pool of seats for seats matching the values for the seat selection parameters that are input by the analyst. KPIs may be dynamically recomputed with each iteration and displayed to the analyst. Based on the values of the KPIs, the analyst can understand the impacts of the seat selection parameters.

For example, an auction campaign may be created from the filtered list of auction seats in Table 5 using the counter constraints and seat selection parameters in Table 6. Specifically, the analyst would like to consider up to 4 seats, having a weight in an inclusive range between 0.2 and 0.99, ranked by highest weight order, and independent of the Flight/Date/Leg/Cabin as long as the RSI constraint is respected.

TABLE 6

| | Total Number of | | | |
|---|---|---|---|---|
| Weight range | Seats | Level | Groups | Order |
| From 0.2 to 0.99 | 4 | Seat | As few as | Highest Weight |
| | | | possible | First |

The first seat selected by the system 12 is the seat with the highest weight (respecting the RSI constraint); here, the seat that is designated as RSI 1 on Flight Number 6X 123 on 12MAR in Y cabin with the weight 0.96 is selected as the first seat to offer in an auction campaign. The second seat selected is the seat with the highest weight (respecting the RSI constraint); here the seat that is designated as RSI 1 on Flight Number 6X 123 on 10MAR in Y cabin with the weight 0.93 is selected as the second seat to offer in an auction campaign. The third seat selected is the seat with the highest weight (respecting the RSI constraint); here the seat that is designated as RSI 1 on Flight Number 6X 456 on 10MAR in Y cabin with the weight 0.88 is selected as the third seat to offer in an auction campaign. The fourth and last seat selected is the seat with the highest weight (respecting the RSI constraint); here the seat that is designated as RSI 2 on Flight Number 6X 123 on 12MAR in Y cabin with the weight 0.79 is selected as the fourth seat to offer in an auction campaign.

As another example, an auction campaign may be created from the filtered list of auction seats in Table 5 using the counter constraints and seat selection parameters in Table 7. Specifically, the analyst would like to consider up to 4 seats, having a weight in an inclusive range between 0.2 and 0.99, and ranked by highest weight order, but trying to limit, as much as possible, the number of considered Flight/Dates.

TABLE 7

| | Total Number of | | | |
|---|---|---|---|---|
| Weight range | Seats | Level | Groups | Order |
| From 0.2 to 0.99 | 4 | Flight | As few as | Highest Weight |
| | | Date | possible | First |

The first seat selected is the seat with the highest weight (respecting the RSI constraint); here, the seat selected as the first seat is designated as RSI 1 on Flight Number 6X 123 on 12MAR in Y cabin with the weight 0.96. To limit the number of flight dates being impacted, the second seat selected is the seat with the next RSI on the same Flight Date. The second seat selected as the seat that is designated as RSI 2 on Flight Number 6X 123 on 12MAR in Y cabin with the weight 0.79. To limit the number of flight dates being impacted, the third seat selected is the next RSI of the same flight date. The third seat selected is the seat that is designated as RSI 3 on Flight Number 6X 123 on 12MAR in Y cabin with the weight 0.74. The fourth and last seat selected by the system 12 cannot be made in the same Flight Date because its quota for auction has been reached. As a consequence, the fourth and last seat selected is the seat having the highest weight and a RSI equal to one. Specifically, the fourth and last seat selected is the seat that is designated as RSI 1 on Flight Number 6X 123 on 10MAR in Y cabin with the weight 0.93.

As yet another example, an auction campaign may be created from the filtered list of auction seats in Table 5 using the counter constraints and seat selection parameters in Table 8. Specifically, the analyst would like to consider up to 4 seats, having a weight in an inclusive range between 0.2 and 0.99, and randomly selected while still respecting the RSI constraint, but trying to increase, as much as possible, the number of considered Flight/Dates.

TABLE 8

| | Total Number of | | | |
|---|---|---|---|---|
| Weight range | Seats | Level | Groups | Order |
| From 0.2 to 0.99 | 4 | Flight | As many as | Random |
| | | Date | possible | Weight |

The first seat is randomly selected. For example, the first seat that is selected may be the seat in the pool that is designated as RSI 1 on Flight Number 6X 456 on 10MAR in Y cabin with the weight 0.88. Because there are Flight Dates with seats in the pool having a RSI equal to 1 that have not yet been considered, the second seat is randomly selected from this list of flight dates having a RSI equal to 1. For example, the second seat that is selected may be the seat in the pool that is designated as RSI 1 on Flight Number 6X 123 on 10MAR in Y cabin with the weight 0.93. Because there are Flight Dates with seats in the pool having a RSI equal to 1 that have not yet been considered, the third seat is randomly selected from this list of flight dates having a RSI equal to 1. For example, the third seat that is selected may be the seat in the pool that is designated as RSI 1 on Flight Number 6X 456 on 12MAR in Y cabin with the weight 0.68. Because there are still Flight Dates with seats in the pool having a RSI equal to 1 that have not yet been considered, the fourth and last seat is randomly selected from this list of flight dates having a RSI equal to 1. For example, the third seat that is selected may be the seat in the pool that is designated as RSI 1 on Flight Number 6X 123 on 12MAR in Y cabin with the weight 0.96.

As yet another example, an auction campaign may be created from the filtered list of auction seats in Table 5 using the counter constraints and seat selection parameters in Table 9. Specifically, the analyst would like to consider up to 4 seats, having a weight in an inclusive range between 0.2 and 0.99, and selected in weight order, but trying to increase, as much as possible, the number of considered Flight/Dates.

TABLE 9

| | Total Number | | | |
|---|---|---|---|---|
| Weight range | of Seats | Level | Groups | Order |
| From 0.2 to 0.99 | 4 | Flight | As many as | Highest |
| | | Number | possible | Weight First |

The first selected seat is the seat with the highest weight (respecting the RSI constraint); here the first seat is the seat that is RSI 1 on Flight Number 6X 123 on 12MAR in Y cabin with the weight 0.96. The second selected seat is the seat with the highest weight value but in one of the other flight numbers. Specifically, the second seat is the seat that is designated as RSI 1 on Flight Number 6X 456 on 12MAR in Y cabin with the weight 0.96. Because all possible flight numbers have at least one seat already selected, the third seat is the seat having the highest weight order. Specifically, the third seat is the seat that is designated as RSI 1 on Flight Number 6X 456 on 10MAR in Y cabin with the weight 0.93. Because all possible flight numbers have at least one seat already selected, the fourth and last seat is the seat having the highest weight order. Specifically, the fourth and last seat is the seat that is designated as RSI 2 on Flight Number 6X 456 on 12MAR in Y cabin with the weight 0.79.

As yet another example, an auction campaign may be created from the filtered list of auction seats in Table 5 using the counter constraints and seat selection parameters in Table 10. Specifically, the analyst would like to consider an unlimited number of seats, having a weight in an inclusive range between 0.80 and 0.99, and ranked in weight order, and independent of the Flight/Date/Leg/Cabin as long as the RSI constraint is respected.

TABLE 10

| | Total Number | | | |
|---|---|---|---|---|
| Weight range | of Seats | Level | Groups | Order |
| From 0.80 to 0.99 | | Seat | As many as | Highest Weight |
| | | | possible | First |

The first selected seat is the seat with the highest weight (respecting the RSI constraint); here the first seat is the seat that is designated as RSI 1 on Flight Number 6X 123 on 12MAR in Y cabin with the weight 0.96. The second seat is the seat that is designated as RSI 1 on Flight Number 6X 123 on 10MAR in Y cabin with the weight 0.93. The third seat is the seat that is designated as RSI 1 on Flight Number 6X 456 on 10MAR in Y cabin with the weight 0.88. Even if it has a weight higher than 0.8, the system 12 cannot select the seat with RSI 3 on the O&D LHR-SIN for Flight Number 6X 123 on 10MAR in Y having a weight of 0.84 (i.e., higher than the lower limit of 0.80) because the seat that is RSI 2 on this Flight/Date/Leg/Cabin does not respect the weight condition.

The Campaign Revenue Constraints are elements that need to be validated against each any eligible seat to be really part of the pre-booked ones in the Auction. These constraints are checked when the Auction Campaign Application process is really performed (i.e. not before the real activation). The main revenue constraints may be effective yield range (min & max), price range (min & max), fare basis exclusion, etc.

The analyst may define elements for an auction campaign, such as booking class, validity period, pricing details, initial price, price curve, and point of sale, as inputs to the system 12. The booking class is required to understand which type of product is considered in the auction (e.g., economy cabin, business cabin, refundable ticket, non-refundable ticket, etc.). The analyst also inputs pricing details of the seats that are saleable in the auction, such as an initial price value, a price curve, and a validity period specifying when the seats defined in the campaign are saleable through the auction platform. The initial price value may be an exact value, defined by the analyst and overriding the standard price of the booking class and point of sale considered, or may be a percentage of the standard price of the booking class and point of sale considered. The price curve may define price reduction over time, time slots, and minimum value of price.

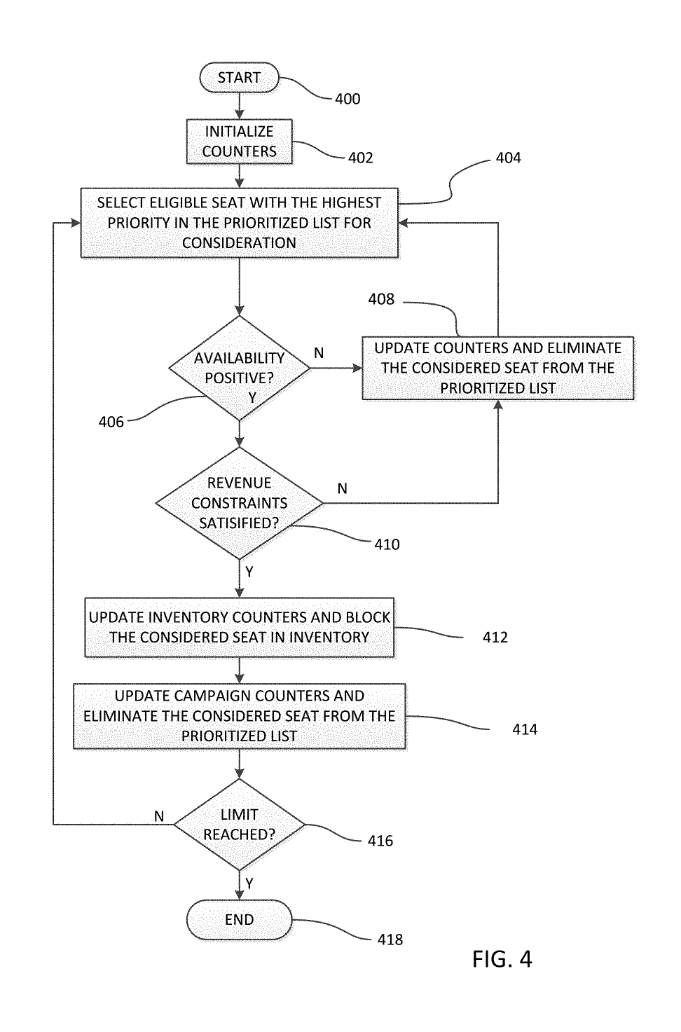

FIG. 4 presents a flow chart detailing a process 400 to activate a business rule so as to initiate an auction campaign to sell the eligible seats and the conduct of the auction campaign after initiation. When the business rule is activated, the system retrieves the details of the business rule for the auction campaign and an iterative process begins to conduct the auction campaign. In block 402, the auction campaign system 12 sets the different counters (e.g., the number of seats being pre-booked in the auction, the number of different flight dates impacted, etc. . . . ) for the auction campaign to an initial value of zero.

In block 404, the remaining seat with the highest priority in the prioritized list is evaluated in a loop that comprises instructions that are continually repeated with termination based upon on the campaign counters and the corresponding constraints as limits. The auction campaign system 12 performs elements of the loop so long as the limits are not reached. The auction campaign system 12 then computes and/or retrieves the availability, the yield, and the standard booking price for the remaining seat with the highest priority in the prioritized list based on the booking class defined by the distribution characteristics section and the flight details from the auction campaign database.

In block 406, the auction campaign system 12 verifies that the availability is strictly positive for the eligible seat under consideration and also verifies that the yield value and the price value for the eligible seat under consideration are within the respective revenue constraints for yield range and price range. If outside of these revenue constraints, the system updates the relevant counters and removes the seat under consideration from the list of remaining eligible seats in the prioritized filtered list of auction seats (block 408). The next eligible seat in the prioritized filtered list of auction seats is then selected as control is returned to block 404.

If the revenue constraints are respected by the seat under consideration, the system checks whether the flight-date and cabin has sufficient remaining auction availability (i.e., auction availability (leg and cabin) greater than 0) in block 410. If there is no auction availability, the system updates the relevant counters and goes to the next remaining seat in the prioritized filtered list of auction seats (block 408). The next eligible seat in the prioritized filtered list of auction seats is then selected as control is returned to block 404.

If the auction availability is positive, the auction campaign system 12 creates or updates a negoblock corresponding to the auction campaign considered in the relevant booking class, and increments the counter of bookings under auction on the related leg and cabin (block 416). The counter of seats potentially available for auction on the considered flights is decremented. The details (pricing details, availability, etc.) of the seat under consideration are attached to the business rule for the auction campaign in the campaign database. The system then removes the considered seat from the prioritized list of eligible seats, and the next seat in the prioritized list is considered so long as the counter constraints are respected.

A seat that is blocked by the loop for future sales impacts the cabin availability. The seat index that is used for revenue control availability is decremented. As a result, the price of a seat for sales through normal channels and outside of the auction campaign may be impacted with a price increase.

When the looping has concluded in block 408, the list of seats to be included in the auction campaign is determined. These seats are blocked through negotiated space in the availability module 20, and the inventory counters at the inventory system 14 are updated accordingly.

With the assistance of a client device 16, an end user (e.g., a passenger or a travel agent) can access a list of active auctions at a dedicated web page or through a cryptic command entry. Auction campaigns may be identified according to departure point, arrival point, travel date, the effective period (start/end) for the auction, the maximum price, the cabin, the return date, etc. for display to the end user. The reply to the end user is based on the content of the auction seats database. The current price may be determined based on campaign database information. After the bidder selects an auction and bids, counters are updated. Specifically, the auction seats database is updated by the auction campaign system 12 to decrement the number of seats under auction and to increment the counter of seats sold via auction. In addition, at the inventory database and in response to a bid, the counter of bookings under auction is decremented on the considered leg and cabin while the counter of bookings done via auction is incremented.

The embodiments of the invention are necessarily rooted in computer technology in order to overcome a problem specifically arising in the realm of computers and computer networks. Specifically, the realm of computer networks facilitates the use of computerized yield management and revenue management principles. Seats are sold through inventory availability. To conduct a conventional seat auction, a block of seats would be reserved in inventory for a flight-date and sold via bidding with a dedicated auction. The problem created by conventional seat auctions is that the seats are blocked without consideration of yield or revenue management principles.

The embodiments of the present invention provide an auction system that necessarily invokes principles of revenue management to solve the problem encountered by conventional seat auctions by expanding the way in which blocked seats are selected for auctioning, specifically with the use of yield or revenue management principles to optimize revenue in a non-conventional approach to auctioning. Consequently, the embodiments of the invention are directed to more than merely storing data in a logical table, organizing data in a logical table, and retrieving data from a logical table. Instead, the embodiments of the invention treat data differently from conventional database structures and logical tables. Specifically, the embodiments of the invention permit the auctioning of seats to be expanded and optimized across multiple flight-dates of multiple flights in an airline network with a logical table that permits comparisons between seats in inventory for such multiple flight-dates and flights, not merely the selection of a single flight-date as is conventional. This is accomplished, at least in part, through the use of a logical table including the remaining seat index associated with the seats available for auction and associated weights that are assigned to the available seats.

With reference to FIG. 5, the systems, modules, and databases of the operating environment 10 may be implemented on one or more computer devices or servers, such as exemplary computer system 30. The computer system 30 may include a processor 32, a memory 34, a mass storage memory device 36, an input/output (I/O) interface 38, and a Human Machine Interface (HMI) 40. The computer system 30 may also be operatively coupled to one or more external resources 42 via the network 25 or I/O interface 38. External resources may include, but are not limited to, servers, databases, mass storage devices, peripheral devices, cloud-based network services, or any other suitable computer resource that may be used by the computer system 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 46 that resides in memory 34. The operating system 46 may manage computer resources so that computer program code embodied as one or more computer software applications, such as an application 48 residing in memory 34, may have instructions executed by the processor 32. In an alternative embodiment, the processor 32 may execute the application 48 directly, in which case the operating system 46 may be omitted. One or more data structures 49 may also reside in memory 34, and may be used by the processor 32, operating system 46, or application 48 to store or manipulate data.

The I/O interface 38 may provide a machine interface that operatively couples the processor 32 to other devices and systems, such as the network 25 or external resource 42. The application 48 may thereby work cooperatively with the network 25 or external resource 42 by communicating via the I/O interface 38 to provide the various features, functions, applications, processes, or modules comprising embodiments of the invention. The application 48 may also have program code that is executed by one or more external resources 42, or otherwise rely on functions or signals provided by other system or network components external to the computer system 30. Indeed, given the nearly endless hardware and software configurations possible, persons having ordinary skill in the art will understand that embodiments of the invention may include applications that are located externally to the computer system 30, distributed among multiple computers or other external resources 42, or provided by computing resources (hardware and software) that are provided as a service over the network 25, such as a cloud computing service.

The HMI 40 may be operatively coupled to the processor 32 of computer system 30 in a known manner to allow a user to interact directly with the computer system 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 44 may reside on the mass storage memory device 36, and may be used to collect and organize data used by the various systems and modules described herein. The database 44 may include data and supporting data structures that store and organize the data. In particular, the database 44 may be arranged with any database organization or structure including, but not limited to, a relational database, a hierarchical database, a network database, an object-oriented database, or combinations thereof. A database management system in the form of a computer software application executing as instructions on the processor 32 may be used to access the information or data stored in records of the database 44 in response to a query, where a query may be dynamically determined and executed by the operating system 46, other applications 48, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database. The database 46 may comprise the revenue controls database 22, the business rules database 24, and/or the auction seats database 26. In particular, the logical tables, upon which the auction campaigns are based, may be included as a data structure in the database 46.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. For example, the revenue management system may receive feedback from the campaign promotion module that the revenue management system can use as metrics to tailor forecasts and manage the impact of auctions on demand. The feedback may include, at flight/date/cabin level, the number of seats reserved for auctions, the number of ongoing auctions, the number of bookings completed through auctions, and the starting price and auctioned price of each booking during the auction. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for managing an auction, the system comprising:
one or more processors; and
a memory coupled to the one or more processors, the memory storing data comprising program code that, when executed by the one or more processors, causes the system to:
determine a plurality of inventory controls;
determine a pool comprised of a first plurality of inventory items that are auction eligible from an inventory item network based on the inventory controls;
determine a reference index to assign to each of the first plurality of inventory items in the pool;
filter the first plurality of inventory items based on at least one inventory item characteristic to define a second plurality of inventory items; and
filter the second plurality of inventory items based on at least one constraint and the reference index associated with each of the second plurality of inventory items to determine an order in which at least some of the second plurality of inventory items are made available for bidding in the auction.

2. The system of claim 1 wherein the program code further causes the system to:
determine a weight to associate with each of the first plurality of inventory items in the pool,
wherein the filtering of the second plurality of inventory items is further based on the weight associated with each of the second plurality of inventory items.

3. The system of claim 2 wherein the program code causes the system to filter the second plurality of inventory items based on the at least one constraint and the reference index associated with each of the second plurality of inventory items by:
applying a weight range that must be satisfied by the second plurality of inventory items in order to be made available for bidding in the auction.

4. The system of claim 1 wherein the program code causes the system to filter the second plurality of inventory items based on the at least one constraint and the reference index associated with each of the second plurality of inventory items by:
applying a plurality of selection parameters that determine the order in which the second plurality of inventory items are to be made available for bidding in the auction.

5. The system of claim 4 wherein the program code causes the system to filter the second plurality of inventory items based on the at least one constraint and the reference index associated with each of the second plurality of inventory items by:
determining a weight to associate with each of the first plurality of inventory items in the pool,
wherein at least one of the selection parameters is an ordering parameter based on the weight associated with each of the second plurality of inventory items.

6. The system of claim 4 wherein the second plurality of inventory items are organized at different levels according to a plurality of groups, and at least one of the selection parameters is a coverage level parameter that sets one of the groups as a level at which the second plurality of inventory items are filtered.

7. The system of claim 4 wherein the second plurality of inventory items are organized at different levels according to a plurality of groups, and at least one of the selection parameters is a coverage type parameter that limits selection of the second plurality of inventory items from any single one of the groups.

8. The system of claim 1 wherein the second plurality of inventory items are distributed among a plurality of flight-dates and origin-destinations in the inventory item network.

9. The system of claim 1 wherein the program code causes the system to filter the second plurality of inventory items based on the at least one constraint and the reference index associated with each of the second plurality of inventory items by:
applying a numerical limit representing a maximum number of the second plurality of inventory items to be made available for bidding in the auction.

10. The system of claim 1 wherein the program code causes the system to filter the second plurality of inventory items based on the at least one constraint and the reference index associated with each of the second plurality of inventory items by:
applying one or more revenue constraints that are used to validate the second plurality of inventory items.

11. A method of managing an auction, the method comprising:
determining, by one or more processors, a plurality of inventory controls;
determining, by the one or more processors, a pool comprised of a first plurality of inventory items that are auction eligible from an inventory item network based on the inventory controls;
determining, by the one or more processors, a reference index to assign to each of the first plurality of inventory items in the pool;
filtering, by the one or more processors, the first plurality of inventory items based on at least one inventory item characteristic to define a second plurality of inventory items; and
filtering, by the one or more processors, the second plurality of inventory items based on at least one constraint and the reference index associated with each of the second plurality of inventory items to determine an order in which at least some of the second plurality of inventory items are made available for bidding in the auction.

12. The method of claim 11 comprising:
determining, by the one or more processors, a weight to associate with each of the first plurality of inventory items in the pool,
wherein the filtering of the second plurality of inventory items is further based on the weight associated with each of the second plurality of inventory items.

13. The method of claim 12 wherein filtering the second plurality of inventory items based on the at least one constraint and the reference index associated with each of the second plurality of inventory items comprises:
applying, by the one or more processors, a weight range that must be satisfied by the second plurality of inventory items in order to be made available for bidding in the auction.

14. The method of claim 11 wherein filtering the second plurality of inventory items based on the at least one constraint and the reference index associated with each of the second plurality of inventory items comprises:
applying, by the one or more processors, a plurality of selection parameters that determine the order in which the second plurality of inventory items are to be made available for bidding in the auction.

15. The method of claim 14 wherein filtering the second plurality of inventory items based on the at least one constraint and the reference index associated with each of the second plurality of inventory items comprises:
determining, by the one or more processors, a weight to associate with each of the first plurality of inventory items in the pool,
wherein at least one of the selection parameters is an ordering parameter based on the weight associated with each of the second plurality of inventory items.

16. The method of claim 14 wherein the second plurality of inventory items are organized at different levels according to a plurality of groups, and at least one of the selection parameters is a coverage level parameter that sets one of the groups as a level at which the second plurality of inventory items are filtered.

17. The method of claim 14 wherein the second plurality of inventory items are organized at different levels according to a plurality of groups, and at least one of the selection parameters is a coverage type parameter that limits selection of the second plurality of inventory items from any single one of the groups.

18. The method of claim 11 wherein the second plurality of inventory items are distributed among a plurality of flight-dates and origin-destinations in the inventory item network.

19. The method of claim 11 wherein filtering the second plurality of inventory items based on the at least one constraint and the reference index associated with each of the second plurality of inventory items comprises:
applying a numerical limit representing a maximum number of the second plurality of inventory items to be made available for bidding in the auction.

20. The method of claim 11 wherein filtering the second plurality of inventory items based on the at least one constraint and the reference index associated with each of the second plurality of inventory items comprises:
applying one or more revenue constraints that are used to validate the second plurality of inventory items.

21. A computer program product for managing an auction, the computer program product comprising:
a non-transitory computer-readable storage medium; and
program code stored on the non-transitory computer-readable storage medium that, when executed by one or more processors, causes the one or more processors to:
determine a plurality of inventory controls;
determine a pool comprised of a first plurality of inventory items that are auction eligible from an inventory item network based on the inventory controls;
determine a reference index to assign to each of the first plurality of inventory items in the pool;
filter the first plurality of inventory items based on at least one inventory item characteristic to define a second plurality of inventory items; and
filter the second plurality of inventory items based on at least one constraint and the reference index associated with each of the second plurality of inventory items to determine an order in which at least some of the second plurality of inventory items are made available for bidding in the auction.
